(19) United States
(12) Patent Application Publication
(10) Pub. No.: US 2025/0333667 A1
(43) Pub. Date: Oct. 30, 2025

(54) PARTICULATE LAUNDRY SCENT ADDITIVE INCLUDING A BUILDER

(71) Applicant: The Procter & Gamble Company, Cincinnati, OH (US)

(72) Inventor: Kristin Rhedrick WILLIAMS, West Chester, OH (US)

(21) Appl. No.: 18/644,722

(22) Filed: Apr. 24, 2024

(51) Int. Cl. C11D 3/50; C11D 3/10; C11D 3/20; C11D 3/37; C11D 3/40

(52) U.S. Cl. CPC C11D 3/505; C11D 3/10; C11D 3/2079; C11D 3/2086; C11D 3/3707; C11D 3/40

(57) ABSTRACT

A composition including: about 1% to about 10% by weight of the composition a builder; and a plurality of fragrance particles, wherein the fragrance particles include: about 25% to about 80% by weight of the composition a first dispersant that is solid at 20 degrees Celsius; about 9% to about 25% by weight of the composition a first solubility agent; about 9% to about 30% by weight of the composition a second solubility agent; about 1% to about 20% by weight of the composition perfume.

### FIELD OF THE INVENTION

Fabric care laundry scent additives.

### BACKGROUND OF THE INVENTION

Consumers enjoy using particulate laundry scent additives that are delivered through the wash. In particular, consumers like laundry scent additives that are packaged in a manner that enables the consumer to use a custom amount of the laundry scent additive based on the consumer's judgment of how much of the laundry scent additive is needed to provide the desired benefit. Such laundry scent additives are conveniently provided through the wash along with a fully formulated fabric care composition.

A typical particulate laundry scent additive consists of a dispersant and perfume. The fragrance particles dissolve or disperse in the wash to release the perfume and perfume is deposited on the articles that are being laundered. A common process for manufacturing such particulate laundry scent additives includes using water to carry the perfume as a perfume in water emulsion or water in perfume emulsion or using water to carry encapsulated perfume to a melt of the dispersant and mixing the two together and then fabricating fragrance particles from the mixture.

An abundance of water in particulate laundry scent additives is problematic because the water tends to weaken the structural integrity of the particle. This can result in there being an upper limit on the weight fraction of perfume that can be provided in a particulate laundry scent additive. The abundance of water can be managed by adding a quantity of anhydrous salt to the melt to bind at least some of the water, thereby improving the structural integrity of the particle.

Forming solid fragrance particles that include a dispersant and unencapsulated perfume and or encapsulated perfume can be challenging. Solubility agents may be provided to help improve the formation of and structural stability of such fragrance particles. Some such solubility agents also result in changes to or moderation of the pH of the wash liquor into which such fragrance particles dissolve.

For wash conditions in which the water used to form the wash liquor contains hardness, there is the potential for formulation components of fragrance particles and hardness in the water to combine to form low solubility salts. These low solubility salts have the potential to deposit on the clothing being laundered or on components of the washing machine in which the clothes are laundered. Deposited salts can result in clothes that appear dirty and unsightly residue being deposited on the surface of the drum in the washing machine and on the window of the washing machine through which users of the washing machine are able to monitor progress of the laundry treatment cycle they have chosen. With this limitation in mind, there is a continuing unaddressed need for particulate laundry scent additives that when used do not leave unacceptable levels of deposited salts on the laundry or washing machine.

### SUMMARY OF THE INVENTION

A composition comprising: about 1% to about 10% by weight of the composition a builder; and a plurality of fragrance particles, wherein the fragrance particles comprise: about 25% to about 80% by weight of the composition a first dispersant that is solid at 20 degrees Celsius; about 9% to about 25% by weight of the composition a first solubility agent; about 9% to about 30% by weight of the composition a second solubility agent; and about 1% to about 20% by weight of the composition perfume.

### BRIEF DESCRIPTION OF THE DRAWINGS

FIG. 1. An apparatus for forming fragrance particles.

### DETAILED DESCRIPTION OF THE INVENTION

One of the challenges associated with providing high levels of perfume in particulate laundry scent additives is managing water that is used to manufacture the fragrance particles. Fragrance particles can be produced by forming a melt of a first dispersant, for example a water soluble polymer, and mixing the melted first dispersant and perfume together. This mixture can be extruded from a die to produce a noodle that is cut into small fragrance particles. Optionally the mixture can be fed through a rotoformer or other device having apertures to deposit drops of the mixture onto a belt and the drops subsequently cool or otherwise solidify to form fragrance particles.

Water is commonly used to carry perfume in melt processing apparatuses. The perfume may be unencapsulated perfume that is transported as a perfume in water or water in a perfume emulsion. The perfume may be encapsulated perfume.

To simplify the supply chain and manufacturing processes, a slurry of encapsulated perfume and water can be provided. Optionally, a slurry of perfume delivery systems may be provided as a slurry of perfume delivery system and water. Slurries can be readily handled in product manufacturing processes and the rheological properties of the slurry can be at least partially controlled by the amount of water in the slurry. For a slurry comprising encapsulated perfume, the slurry can comprise encapsulated perfume and water. The slurry can comprise from about 10% to about 50% by weight perfume, about 5% to about 20% by weight encapsulate shell, and about 40% to about 80% by weight water. The slurry can optionally comprise from about 20% to about 40% by weight perfume. The slurry can optionally comprise about 5% to about 15% by weight encapsulate shell. The slurry can optionally comprise from about 50% to about 70% by weight water. The slurry can comprise additional minor materials including, but not limited to, antimicrobial material, antioxidant, stabilizers, rheology modifiers, and stabilizing salts.

In melt processing in which the first dispersant forms a significant fraction of the melt, high quantities of water may not be desirable. An excess of water can result in lengthy drying times for the melt or require that heat be used to dry the fragrance particles, which can make the manufacturing process more expensive than desirable. Further, an excess of water in the melt can weaken the structure of the finished particle. This can occur since water that remains in the structure has little strength per se. If the water is removed by drying, empty voids may be left behind and the voids may weaken the structure of the particle.

To help manage the water in a melt of water soluble polymer, it can be practical to provide an anhydrous salt to the melt. Anhydrous salts have a propensity to hydrate with water from the surrounding environment. The anhydrous salt can be selected based on the melt processing conditions. For melt processing particulate laundry scent additives, the perfume portion of the laundry scent additive can influence the selection of the anhydrous salt.

The temperature of the melt is an important variable to control when manufacturing particulate laundry scent additives. The temperature of the melt ideally does not exceed the flash point or boiling point of the perfume employed. Otherwise, some or all of the perfume will flash or boil off and may not end up in the particulate laundry scent additive. The flash point of perfumes typically used in laundry scent additives may be about 70 C.

The onset of melt of the melt is also an important factor to consider when selecting the first dispersant employed. The first dispersant, optionally a water soluble polymer, should have a water should have an onset of melt that is high enough so that the fragrance particles formed are stable at temperatures that the fragrance particles will experience in the supply chain of transporting the fragrance particles from the manufacturer to the consumer.

The constraints of flash point or boiling point of the perfume and the first dispersant onset of melt may provide for boundaries on the choices for the first dispersant used for making particulate laundry sent additives using melt processes.

The composition can comprise one or more solubility agents. The solubility agents can reduce the amount of time required for the fragrance particles to dissolve in the wash water or wash liquor. The fragrance particles can comprise a first solubility agent and a second solubility agent. The first solubility agent can aid with dissolution of the fragrance particles in the wash water or wash liquor.

The second solubility agent can be salt hydrate. There are a variety of anhydrous salts that hydrate into a salt hydrate and the resulting salt hydrate has a salt hydrate onset of melt above the first dispersant onset of melt that is useful in particulate laundry scent additives. Of these salt hydrates there are some that have a salt hydrate onset of melt that is also below the flash point and boiling point of the perfume. By using a salt hydrate that has a salt hydrate onset of melt that is between the water soluble polymer onset of melt and the flash point or boiling point of the perfume, there is a temperature range within which the melt of the first dispersant (optionally water soluble polymer), perfume, and salt hydrate are melt processable. Further, the salt hydrate can be provided to the melt by introducing an anhydrous salt of the salt hydrate. The anhydrous salt can acquire water in the melt as the anhydrous salt hydrates into a salt hydrate. Moreover, the since hydration occurs above the first dispersant onset of melt, the composition remains melt processable since the dispersant dominates the rheological properties of the melt. If the salt hydrate onset of melt is below the first dispersant onset of melt, once the temperature of the particle reaches a temperature of the salt hydrate onset of melt, the salt hydrate will release its water and the water may dissolve at least some of the first dispersant, which results in an unstable particle.

The amount of anhydrous salt added to a melt that includes water can be computed based on the amount of water in the melt to be managed. The water is managed by the anhydrous salt hydrating into its salt hydrate, thereby acquiring the water being managed. For example, sodium acetate anhydrous, upon exposure to water, can hydrate into sodium acetate trihydrate. This means that 1 mol of sodium acetate anhydrous can combine with 3 mol of water. With knowledge of the amount of water in the melt to be managed, the amount of anhydrous salt added, which ultimately ends up as a salt hydrate, can be determined.

The composition disclosed herein can comprise from about 1% to about 10% by weight of the composition a builder and a plurality of fragrance particles. Optionally, the builder can be provided as a constituent of the fragrance particles. Optionally, the builder can be provided in the composition in a particle other than the fragrance particles. The builder can be provided as a coating or dusting, or partial coating or dusting, carried by the fragrance particles. If the composition comprises builder particles and fragrance particles, the builder particles and the fragrance particles can be contained within a container and be in contact with one another.

The composition can comprise a greater number of fragrance particles than builder particles. The ratio of the number of fragrance particles to builder particles can be greater than 1.1:1. Optionally, the ratio of the number fragrance particles to builder particles can be greater than 2:1, optionally greater than 5:1, optionally greater than 10:1.

### Dispersants

The fragrance particles can comprise a first dispersant that is a solid at 20 degrees Celsius and one atmosphere of pressure. The first dispersant can comprise a water soluble polymer. The first dispersant can function as a carrier for perfume. In the wash, the first dispersant can disperse into the wash liquor and release the perfume into the wash liquor, the perfume subsequently being deposited on the articles being washed.

The first dispersant can be selected from the group consisting of C8-C22 alkyl polyalkoxylate comprising more than about 40 alkoxylate units, ethoxylated nonionic surfactant having a degree of ethoxylation greater than about 30, polyalkylene glycol having a weight average molecular weight from about 2000 to about 15000, and combinations thereof.

The first dispersant can be or comprise a block copolymer having Formulae (1), (1I), (III) or (IV),

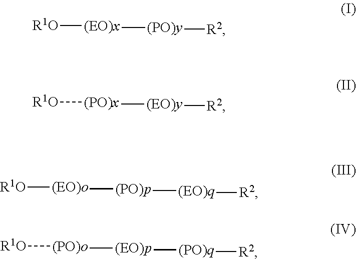

or a combination thereof;
wherein EO is a —CH₂CH₂O— group, and PO is a —CH(CH₃)CH₂O— group;
R¹ and R² independently is 1 or a C1-C22 alkyl group;
x, y, o, p, and q independently is 1-100;
provided that the sum of x and y is greater than 35, and the sum of o, p and q is greater than 35;
wherein the block copolymer has a molecular weight ranging from about 3000 g/mol to about 15,000 g/mol.

The first dispersant can be or comprise a block copolymer or block copolymers, for example a block copolymer based on ethylene oxide and propylene oxide selected from the group of PLURONIC-F38, PLURONIC-F68, PLURONIC-F77, PLURONIC-F87, PLURONIC-F88, and combinations thereof. PLURONIC materials are available from BASF.

The first dispersant can be selected from the group of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof. In one embodiment the polymer comprises polyacrylates, especially sulfonated polyacrylates and water-soluble acrylate copolymers; and alkylhydroxy cellulosics such as methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates. In yet another embodiment the first dispersant can be selected from the group consisting of PVA; PVA copolymers; hydroxypropyl methyl cellulose (HPMC); and mixtures thereof.

The first dispersant can be selected from the group of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, cellulose, alkyl cellulosics, methyl cellulose, ethyl cellulose, propyl cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, starch, modified starch, gelatin, alginates, xyloglucans, hemicellulosic polysaccharides, xylan, glucuronoxylan, arabinoxylan, mannan, glucomannan, galactoglucomannan, natural gums, pectin, xanthan, carrageenan, locus bean, arabic, tragacanth, polyacrylates, sulfonated polyacrylates, water-soluble acrylate copolymers, alkylhydroxy cellulosics, methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates, polyvinyl alcohol copolymers, hydroxypropyl methyl cellulose, and mixtures thereof.

The first dispersant can be an organic material. Organic first dispersants may provide a benefit of being readily soluble in water.

The first dispersant can be selected from the group of polyethylene glycol, polypropylene glycol polyoxoalkylene, polyethylene glycol fatty acid ester, polyethylene glycol ether, starch, and mixtures thereof.

The first dispersant can be polyethylene glycol (PEG). PEG can be a convenient material to employ to make fragrance particles because it can be sufficiently water soluble to dissolve during a wash cycle when the fragrance particles have the range of mass disclosed herein. Further, PEG can be easily processed as melt. The onset of melt temperature of PEG can vary as a function of molecular weight of the PEG. The fragrance particles can comprise about 25% to about 80% by weight PEG having a weight average molecular weight from about 2000 Da to about 15000 Da. PEG has a relatively low cost, may be formed into many different shapes and sizes, minimizes unencapsulated perfume diffusion, and dissolves well in water. PEG comes in various weight average molecular weights. A suitable weight average molecular weight range of PEG includes from about 3,000 Da to about 13,000 Da, alternatively from about 4,000 Da to about 13,000 Da, alternatively from about 4,000 Da to about 12,000 Da, alternatively from about 4,000 Da to about 11,000 Da, alternatively from about 5,000 Da to about 11,000 Da, alternatively from about 6,000 Da to about 10,000 Da, alternatively from about 7,000 Da to about 9,000 Da, alternatively combinations thereof. PEG is available from BASF, for example PLURIOL E 8000, or other PLURIOL product. The first dispersant can be a mixture of two or more polyethylene glycol compositions, one having a first weight average molecular weight (e.g. 9000 Da) and the other having a second weight average molecular weight (e.g. 4000 Da), the second weight average molecular weight differing from the first weight average molecular weight.

The fragrance particles can comprise from about 25% to about 80% by weight of the composition, and any whole percentages or ranges of whole percentages within any of the aforementioned range, first dispersant. Optionally, the composition can comprise from about 35% to about 70%, optionally about 40% to about 60%, by weight, and any whole percentages or ranges of whole percentages within any of the aforementioned ranges, of the composition the first dispersant.

The first dispersant can comprise a material selected from the group of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The first dispersant can comprise: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; and a polyethylene glycol fatty alcohol ether of formula HO—(C₂H₄O)ₛ—(CH₂)ₜ)—CH₃ wherein s is from about 30 to about 250 and t is from about 10 to about 30.

The first dispersant can comprise from about 5% to about 70% by weight of the composition of polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The first dispersant can comprise from about 0.2% to about 20% by weight of the composition polyethylene glycol fatty acid ester of formula (C₂H₄O)_{q}—C(O)O—(CH₂)ᵣ—CH₃ wherein q is from about 20 to about 200 and r is from about 10 to about 30.

The first dispersant can comprise from about 0.2% to about 8% by weight of the composition of polyethylene glycol fatty alcohol ether of formula HO—(C₂H₄O)ₛ—(CH₂)ₜ)—CH₃ wherein s is from about 30 to about 250 and t is from about 10 to about 30.

The fragrance particles can comprise from about 25% to about 80% by weight of the composition first dispersant. Optionally, the fragrance particles can comprise from about 35% to about 70%, optionally about 40% to about 60%, by weight, and any whole percentages or ranges of whole percentages within any of the aforementioned ranges, of the composition the first dispersant. Optionally, each of the fragrance particles can comprise from about 45% to about 80%, or even from about 50% to about 80%, by weight of the composition first dispersant.

The first dispersant can have a first dispersant onset of melt less than 58 C. Such a first dispersant can be practical if the second solubility agent is a salt hydrate that has a salt hydrate onset of melt greater than 58 C. By having the first dispersant onset of melt less than the salt hydrate onset of melt, a melt of the first dispersant that includes the salt hydrate can be processed within the range of temperatures between the first dispersant onset of melt and the salt hydrate onset of melt without the salt hydrate releasing the bound water.

The first dispersant can be selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.

Any of the above materials set forth above as being a first dispersant can be a second dispersant, if a second dispersant is a constituent part of the composition. In composition in which the builder is provided in a plurality of builder particles, the builder particles can comprise the builder and a second dispersant. The second dispersant can disperse into the wash liquor and release the builder into the wash liquor. The second dispersant can be same as the first dispersant.

Optionally, the second dispersant can differ from the first dispersant.

### Perfume

A perfume is an oil or fragrance that includes one or more odoriferous compounds, for example synthetic products of the ester, ether, aldehyde, ketone, alcohol, and hydrocarbon type. Mixtures of various odoriferous substances, which together produce an attractive fragrant note, can be used. Such perfume oils can also comprise natural mixtures of odoriferous compounds, as are available from vegetal sources.

Perfume can be a substantially water insoluble composition comprising perfume components, optionally mixed with a suitable solvent or diluent. Suitable solvents or diluents include compounds selected from the group of ethanol, isopropanol, diethylene glycol monoethyl ether, dipropylene glycol, diethyl phthalate, triethyl citrate, and mixtures thereof.

The perfume can be provided as unencapsulated perfume. The perfume can be provided in a perfume delivery system. Zeolite and cyclodextrine are examples of perfume delivery systems. The perfume can be encapsulated in starch. For example an emulsion of starch and perfume oil can be spray dried to form particles of starch having droplets of perfume dispersed within the starch matrix. Perfume delivery systems can be particulate materials or fine particulate materials that may be difficult to handle in a manufacturing environment due to the possibility that the particles may become suspended in air.

The perfume can be encapsulated perfume. Encapsulated perfume is commonly employed in laundry products. Encapsulated perfume comprises a plurality of droplets of liquid perfume each of which are encapsulated in an encapsulate shell. Perfume may be encapsulated in a water soluble or water insoluble encapsulate shell. Encapsulate shell can comprise melamine-urea-formaldehyde, melamine formaldehyde, urea formaldehyde, starch, and the like materials. The encapsulate shell wall can be a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts; and mixtures thereof. When the encapsulate shell comprises an aminoplast, the aminoplast may comprise polyurea, polyurethane, and/or polyureaurethane. The polyurea may comprise polyoxymethyleneurea and/or melamine formaldehyde. Encapsulates having an encapsulate shell comprising a polysaccharide can be practical. The encapsulate shell can be selected from the group of chitosan, gum arabic, alginate, β-glucan, starch, starch derivatives, plant proteins, gelatin, alyssum homolocarpum seed gum, and combinations thereof.

The perfume can comprise one or more fragrances of plant origin. A fragrance of plant origin is a concentrated hydrophobic liquid containing volatile chemical compound extracted from a plant. The fragrance of plant origin can be selected from the group of allspice berry, angelica seed, anise seed, basil, bay laurel, bay, bergamot, blood orange, camphor, caraway seed, cardamom seed, carrot seed, cassia, catnip, cedarwood, celery seed, chamomile german, chamomile roman, cinnamon bark, cinnamon leaf, citronella, clary sage, clove bud, coriander seed, cypress, elemi, eucalyptus, fennel, fir needle, frankincense, geranium, ginger, grapefruit pink, helichrysum, hop, hyssop, juniper berry, labdanum, lavender, lemon, lemongrass, lime, magnolia, mandarin, marjoram, melissa oil, mugwort, myrrh, myrtle, neroli, niaouli, nutmeg, orange sweet, oregano, palmarosa, patchouli, pennyroyal, pepper black, peppermint, petitgrain, pine needle, radiata, ravensara, rose, rosemary, rosewood, sage, sandalwood, spearmint, spikenard, spruce, star anise, sweet annie, tangerine, tea tree, thyme red, verbena, vetiver, wintergreen, wormwood, yarrow, ylang ylang extra, and ylang ylang III, and mixtures thereof.

The fragrance particles can comprise from about 1% to about 20% by weight of the composition perfume, optionally from about 1% to about 15%, optionally from about 1% to about 12%, optionally from about 1% to about 15%, optionally from about 2% to about 20%, optionally from about 8% to about 10% by weight of the composition perfume, optionally any range of whole percentages within any of the aforesaid ranges.

### Solubility Agents

The composition described herein can comprise one or more solubility agents. The solubility agents can reduce the amount of time required for the fragrance particles to dissolve in the wash water or wash liquor. The fragrance particles can comprise a first solubility agent and a second solubility agent.

The fragrance particles can comprise from about 9% to about 25%, optionally from about 15% to about 20%, by weight of the composition the first solubility agent. The fragrance particles can comprise from about 9% to about 25%, optionally about 15% to about 20%, by weight of the composition the second solubility agent.

The first solubility agent can be a disintegrant that promotes dispersal and or disintegration of the fragrance particles. The first solubility agent can be a salt of carbonate. The first solubility agent can be selected from the group of sodium carbonate, sodium bicarbonate, calcium carbonate, clay, and combinations thereof. The first solubility agent can be bentonite. The first solubility agent can be an inorganic material. The first solubility agent can differ from the first dispersant.

The first solubility agent can have an onset of melt of about 40 C. The first solubility agent can be insoluble in the second solubility agent. The first solubility agent can act to increase the viscosity of the melt composition so as to render the melt composition more easily processable.

The second solubility agent can be a salt hydrate. The salt hydrate can be formed by anhydrous salt being introduced into a melt comprising the first dispersant, perfume, and water or optionally a melt comprising the first dispersant, one or both of the first solubility agent and the second solubility agent, perfume, and water.

The salt hydrate can have an onset of melt greater than 40 C. Salt hydrates having such an onset of melt can be practical since 40 C is a temperature representative of the temperatures that finished fragrance particles might be exposed to during shipping and storage. The salt hydrate will tend to melt at a temperature greater than its onset of melt, which can result in instability of the fragrance particles.

The salt hydrate can be selected from the group of: calcium chloride tetrahydrate, calcium nitrate tetrahydrate, zinc nitrate trihydrate, zinc nitrate dihydrate, potassium fluoride dihydrate, iron nitrate nonahydrate, sodium dihydrogen phosphate heptahydrate, sodium dihydrogen phosphate dihydrate, sodium acetate trihydrate, sodium aluminum sulfate dodecahydrate, aluminum nitrate nonahydrate, lithium acetate dihydrate, sodium phosphate dodecahydrate, sodium thiosulfate pentahydrate, tetrasodium pyrophosphate decahydrate, barium hydroxide octahydrate, aluminum sulfate octadecahydrate, magnesium carbonate trihydrate, magnesium nitrate hexahydrate, magnesium nitrate dihydrate, magnesium sulfate heptahydrate, magnesium chloride hexahydrate, sodium sulfate decahydrate, calcium chloride hexahydrate, and combinations thereof.

The salt hydrate can be sodium acetate trihydrate. Sodium acetate trihydrate can have an onset of melt of about 58 C.

The first solubility agent, the second solubility agent, and the first dispersant can each differ from the others. For example, the first solubility agent can differ from the first dispersant. The first solubility agent can differ from the first dispersant and second solubility agent. The second solubility agent can differ from the first dispersant. The second solubility agent can differ from the first dispersant and the first solubility agent.

The fragrance particles can further comprise acid. The acid can lower the pH of the particle, which may help to prevent discoloration of the particle. For example, sodium acetate trihydrate can tend to raise the pH of the particle and acid can be used to lower the pH. The fragrance particles can comprise from about 0.5% to about 5% by weight of the composition acid. The acid can be selected from the group consisting of citric acid, formic acid, and mixtures thereof.

### Fragrance Particles

Each of the fragrance particles can comprise: about 25% to about 80% by weight of the composition first dispersant; about 9% to about 25% by weight of the composition first solubility agent; about 9% to about 30% by weight of the composition second solubility agent; and about 1% to about 20% by weight of the composition perfume. The perfume can be dispersed in a matrix comprising the first dispersant, the first solubility agent, and the second solubility agent. Optionally the perfume can be dispersed in a matrix comprising the first dispersant, the first solubility agent, the second solubility agent, and the builder, if the builder is provided as part of the fragrance particles.

The fragrance particles can each have a mass from about 1 mg to about 500 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller fragrance particles are thought to provide for better packing of the fragrance particles in a container and faster dissolution in the wash. The composition can comprise less than 10% by weight of fragrance particles having an individual mass less than about 10 mg. This can reduce the potential for dust.

The fragrance particles disclosed herein, in any of the embodiments or combination disclosed, can have a shape selected from the group consisting of a sphere, hemisphere, oblate sphere, cylindrical, polyhedral, and oblate hemisphere. The fragrance particles may be hemispherical, compressed hemispherical, or have at least one substantially flat or flat surface. The fragrance particles can have at least one substantially flat or flat surface and a curved surface opposite the substantially flat or flat surface. Such fragrance particles may have relatively high surface area to mass as compared to spherical fragrance particles. Dissolution time in water may decrease as a function of increasing surface area, with shorter dissolution time being preferred over longer dissolution time.

The fragrance particles disclosed herein can have ratio of maximum dimension to minimum dimension from about 10 to 1, optionally from about 8 to 1, optionally about 5 to 1, optionally about 3 to 1, optionally about 2 to 1. The fragrance particles disclosed herein can be shaped such that the fragrance particles are not flakes. Fragrance particles having a ratio of maximum dimension to minimum dimension greater than about 10 or that are flakes can tend to be fragile such that the fragrance particles are prone to becoming dusty. The fragility of the fragrance particles tends to decrease with decreasing values of the ratio of maximum dimension to minimum dimension.

The fragrance particles can comprise less than about 10% by weight water. The weight percent of water and ratios of constituent materials to water with respect to the fragrance particles, melt composition, or mixture comprising the first dispersant, the encapsulated perfume, and the sodium acetate trihydrate does not include the water that forms part of the salt hydrate since that water is bound to and is a constituent part of the salt hydrate (in contrast to unbound water).

The fragrance particles can have a fragrance particles onset of melt from about 40 C to about 55 C. Such fragrance particles may be stable within the supply chain from manufacturer to the consumer's household.

### Builder

The fragrance particles can form a constituent part of a composition that comprises a builder and the fragrance particles. The composition can comprise from about 1% to about 10% by weight of the composition a builder. Optionally, the composition can comprise from about 1% to about 8%, optionally from about 2% to about 8%, optionally from about 1% to about 7%, optionally from about 1% to about 5%, optionally any range of whole numbers within about 1% to about 10%, by weight of the composition a builder. The builder can be provided as a particle or a constituent part of a particle other than the fragrance particles. The builder can be provided in a particle that is separable from the fragrance particles. The builder and fragrance particles can be contained within a container and be in contact with one another. Optionally, the builder can be coated on the fragrance particles. The coating of the builder on the fragrance particles can be a dusting or spray coating on part of or the entire surface of the fragrance particles. Optionally, the builder can be dispersed in the fragrance particles. In such an arrangement, the builder can be carried by the first dispersant.

The composition can comprise a plurality of builder particles comprising a second dispersant and the builder. The builder particles can comprise a second dispersant and the builder. The composition can be contained in a container and the builder and fragrance particles can be in contact with one another inside the container. When delivered to the wash, the second dispersant can disperse into the wash liquor and release the builder into the wash liquor.

The second dispersant can be selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof. The second dispersant can be the same as the first dispersant. Optionally, the second dispersant can differ from the first dispersant.

The builder can counteract the detrimental effects of hardness ions such as calcium 2+ and magnesium 2+. The builder can be selected from the group of citric acid, sodium citrate, glutamic acid diacetic acid, ethyl gallate, sodium silicate, sodium metasilicate, diethylenetriamine, diethylenetriaminepentaacetic acid pentasodium salt, diethylenetriaminepentaacetic acid, and methylglycinediacetic acid.

Dye One or both of the fragrance particles and optional builder particles can comprise a dye.

The fragrance particles and optionally builder particles can comprise from about 0.001% to about 0.1%, optionally from about 0.01% to about 0.02% by weight dye. The dye can be any of the LIQUITINT dyes available from Millikin Chemical, Spartanburg, South Carolina, United States of America. The fragrance particles can comprise a first dye and the builder particles can comprise a second dye and the second dye can differ from the first dye. The first dye and second dye can differ in color from one another. Such an arrangement can provide an visual cue to the user that the composition has two different kinds of particles, each of which has a specific function within the composition.

### Process for Forming Fragrance Particles

The fragrance particles can be made by a process comprising multiple steps. A melt composition comprising the first dispersant, the first solubility agent, the second solubility agent and the perfume can be provided. Optionally, the builder can provided in this melt composition, or added to this melt composition, or added to an intermediate of the melt composition, or added later to particles formed from the melt composition.

The melt composition can be prepared in a batch mixer or continuous mixer or made on a bench top by hand mixing the component materials. The first dispersant can be heated to a temperature that is above the first dispersant onset of melt and below the flash point or boiling point of the perfume. The perfume and any accompanying water can be added to the melted first dispersant or vice versa to form a melt composition.

The melt composition can be passed through one or more apertures and deposited on a moving conveyor as an extrudate or as droplets. The mixture can optionally be deposited into depressions of a mold and cooled or allowed to cool so that the mixture solidifies into the fragrance particles. The fragrance particles can be removed from the depressions of the mold to yield the finished product.

Optionally, the fragrance particles can be formed by passing the melt composition through one or more apertures of a distributor and depositing the melt composition on a moving conveyor beneath the one or more apertures. The melt composition may be solidified to form the fragrance particles. The mixture may be deposited on the moving conveyor as an extrudate and the extrudate can be cut to form the fragrance particles. Or the melt composition can be passed through the one or more apertures to form droplets on the moving conveyor and the droplets can be solidified to form the fragrance particles.

The perfume and water of the melt composition can be provided as a slurry comprising the perfume and water. The perfume and water of the melt composition can be provided as a perfume oil in water emulsion or a water in perfume emulsion. Water based slurries can be convenient for delivering perfume, including encapsulated perfume. The perfume can be encapsulated perfume.

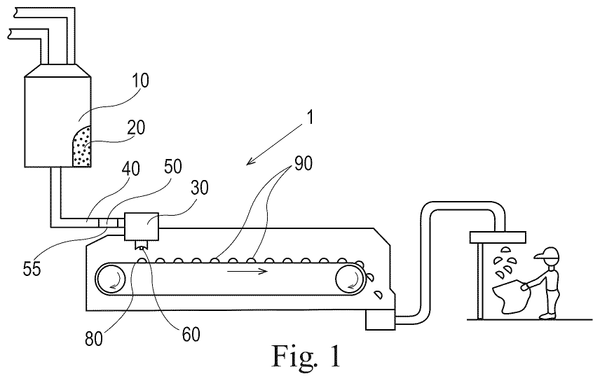

An apparatus 1 for forming fragrance particles is shown in FIG. 1. The melt composition 20 or mixture comprising the first dispersant, first solubility agent, second solubility agent, perfume (unencapsulated perfume and or encapsulated perfume), can be transported to a distributor 30. The distributor 30 can have a plurality of apertures 60. The melt composition 20 or mixture can be passed through the apertures 60 to form droplets on a moving conveyor 80. And the fragrance particles 90 can solidify on the conveyor 80. The conveyor 80 can be actively cooled or the fragrance particles 90 may solidify by ambient cooling. The fragrance particles can be formed using a rotoforming apparatus to deposit droplets of the mixture on a moving conveyor. Optionally, the fragrance particles 90 can be formed by extruding an extrudate of the mixture onto a moving conveyor and cutting the extrudate. The melt composition 20 can be provided in a mixer 10, for example a batch mixer or continuous mixer. The melt composition 20 can be transported to the distributor 30 via a feed pipe 40. Optionally, a mixer 50, such as a static mixer 55, can be provided in line with the feed pipe 40. Optionally the feed pipe 40 may be insulated or provided with a heated jacket.

The second solubility agent can be a salt hydrate. The salt hydrate can be an anhydrous salt that is hydrated or partially hydrated. An anhydrous salt, by way of nonlimiting example sodium acetate anhydrous, can be mixed with the melt composition or a component thereof. The salt hydrate is thereby hydrated to form the salt hydrate, the salt hydrate having a salt hydrate onset of melt. If the anhydrous salt is sodium acetate anhydrous, the sodium acetate anhydrous can be mixed at a weight ratio of the sodium acetate anhydrous to water from about 1:2 to 2:1, optionally from about 0.6:3 to about 1.5:3, and the sodium acetate anhydrous can be hydrated to form sodium acetate trihydrate. The water may be present as part of the perfume that is provided to form the melt composition. For example the perfume may be provided as an emulsion that comprises water or the encapsulated may be provided in a slurry of perfume encapsulates and water. The anhydrous salt can be mixed with the melt composition or a component thereof in a stoichiometrically sufficient amount such that the melt composition has less than about 5% by weight water, that water being free water that is unbound to the salt hydrate.

### Process for Treating Laundry

The composition can be used to treat laundry. For example, the composition can be an additive that is added to or dosed to the washing machine in addition to adding or dosing a fully formulated detergent composition to the washing machine. In use, laundry can be provided in a washing machine. The composition can be dispensed in the washing machine. The laundry can then be contacted with water. The composition can be dissolved in the water to form a laundry treatment liquor. Optionally, the laundry treatment liquor can include a fully formulated laundry detergent dispersed or mixed therein. The laundry treatment liquor can be contacted to the laundry to thereby treat the laundry. Optionally, to aid in dissolution of the composition, an acid treatment composition can be dispensed into the washing machine. The acidic treatment composition can be an aqueous composition. The acidic treatment composition can comprise from about 10% to about 99%, optionally from about 10% to about 50%, optionally from about 10% to about 30%, by weight of the acidic treatment composition organic acid. The organic acid can be acetic acid, citric acid, or a mixture thereof. The organic acid can be selected from the group of acetic acid, lactic acid, adipic acid, aspartic acid, carboxymethyloxymalonic acid, carboxymethyloxysuccinic acid, glutaric acid, hydroxyethlyliminodiacetic acid, iminodiactic acid, maleic acid, malic acid, malonic acid, oxydiacetic acid, oxydisuccinic acid, succinic acid, sulfamic acid, tartaric acid, tartaric-discuccinic acid, tartaric-monosuccinic acid, or mixtures thereof, optionally acetic acid.

The process for treating laundry can be effected by using an array of laundry treatment products. The array of laundry treatment products can comprise a product that is the composition that comprises the builder and fragrance particles and another product that is an acidic treatment composition comprising from about 10% to about 99% by weight of said acidic treatment composition organic acid. The acidic treatment composition can be an aqueous acidic treatment composition. The acidic treatment composition can be provided in an acid treatment composition container. The composition comprising the builder and fragrance particles can be provided in a builder and fragrance particles container. The acidic treatment composition container can be separate from the builder and fragrance particles container.

### Onset of Melt Test Method

Onset of melt is determined using the Onset of Melt Test Method as follows. Differential Scanning Calorimetry (DSC) is used to quantify the temperature at which the onset of melt occurs for the peak melt transition of any given composition of fragrance particles or salt hydrate. The melt temperature measurements are made using a high quality DSC instrument with accompanying software and nitrogen purge capability, such as TA Instruments' model Discovery DSC (TA Instruments Inc./Waters Corporation, New Castle, Delaware, U.S.A.). A calibration check is conducted using an Indium standard sample. The DSC instrument is considered suitable to conduct the test if the onset of melt temperature measured for the Indium standard sample is within the range of 156.3-157.3° C.

A uniform test sample is prepared by obtaining at least 5 g of the composition, which is pulverised via milling into powder form using an analytical milling device, such as the IKA basic analytical mill model A11 B S1 (IKA-Werke GmbH & Co. KG, Staufen im Breisgau, Germany). The milled sample is subsequently sieved through a clean stainless steel sieve with sieve mesh size openings of nominally 1 mm in diameter (e.g. number 18 mesh size). For each sample to be tested, at least two replicate samples are independently milled and measured. A sample of the milled composition weighing approximately 5 mg is placed into the bottom of a hermetic aluminium DSC sample pan, and the sample is spread out to cover the base of the pan. A hermetic aluminium lid is placed on the sample pan, and the lid is sealed with a sample encapsulating press to prevent evaporation or weight loss during the measurement process. The DSC measurements are conducted relative to a reference standard. An empty aluminum DSC sample pan used as the reference standard, in order to measure the delta in heat adsorption of the sample-containing pan versus the empty reference pan.

The DSC instrument is set up to analyze samples using the following cycle configuration selections: Sample Purge Gas is nitrogen set at 50 mL/min; Sampling Interval is set at 0.1 s/point; Equilibrate is set at −20.00° C.; Isothermal Hold is set at 1 min. Data is collected during a single heating cycle using the settings: Ramp is set at 10.00° C./min to 90.00° C.; and Isothermal Hold is set at 90.00° C. for 1 min. A sealed sample pan containing a replicate test sample is carefully loaded into the instrument, as is an empty reference pan. The DSC analysis cycle specified above is conducted and the output data is assessed. The data acquired during the DSC heating cycle is typically plotted with Temperature on the X-axis (in ° C.) and Heat Flow normalized to sample weight (in W/g) on the Y-axis, such that melting points appear as downward (endothermic) peaks since they absorb energy.

A melt transition onset temperature is the temperature at which a deflection is first observed from the baseline previously established for the melt temperature of interest. The Peak Melt temperature is the specific temperature that requires the largest observed differential energy to transition the sample from a solid phase to a melt phase, during the specified DSC heating cycle. For the purpose of this invention, the Onset of Melt temperature is defined as the melt transition onset temperature for the Peak Melt temperature. Additional general information on the DSC technique may be found in the industry standard method ASTM D3418-03—Transition Temperatures of Polymers by DSC.

Using the DSC instrument software, two points are manually defined as the “Start and Stop Integration” baseline limits. The two points selected are on flat regions of the baseline to the left and right sides, respectively, of the melt transition peak detected. This defined area is then used to determine the peak temperature (T) which can be used to report the Peak Melt Temperature. The Onset of Melt temperature for the Peak Melt temperature is then identified by the instrument software.

The Onset of Melt temperature reported is the average result (in ° C.) from the replicate samples of the composition.

### Formulations

Nonlimiting examples of some prospective formulations of the composition are listed in Table 1. The builder (citric acid, and or sodium citrate) is dispersed in the fragrance particles, coated on the fragrance particles, or provided as a separate particle.

TABLE 1
Example formulations of the composition (levels
are percent by weight of the composition).

| Component | Example | | | | |
|---|---|---|---|---|---|
| Material | A | B | C | D | E |

Builder

| | | | | | |
|---|---|---|---|---|---|
| Citric Acid | 7 | 3 | 1 | | |
| Sodium Citrate | | | 1 | 2 | 10 |

Fragrance Particles

| | | | | | |
|---|---|---|---|---|---|
| Polyethylene | — | — | 50 | 65 | 10 |
| Glycol, Weight | | | | | |
| Average | | | | | |
| Molecular | | | | | |
| Weight 4000 | | | | | |
| Da (first | | | | | |
| dispersant) | | | | | |
| Polyethylene | 62 | 55 | — | — | 40 |
| Glycol, Weight | | | | | |
| Average | | | | | |
| Molecular | | | | | |
| Weight 8000 | | | | | |
| Da (first | | | | | |
| dispersant) | | | | | |
| Encapsulated | 3 | 1 | 8 | 2 | 8 |
| Perfume | | | | | |
| Unencapsulated | 7 | 10 | 6 | 6 | 10 |
| Perfume | | | | | |
| Sodium | 10 | 15 | 17 | 20 | 16 |
| Bicarbonate | | | | | |
| (first solubility | | | | | |
| agent) | | | | | |
| Sodium Acetate | 11 | 16 | 17 | 5 | 6 |
| trihydrate | | | | | |
| (second | | | | | |
| solubility | | | | | |
| agent) | | | | | |

Nonlimiting examples of some prospective formulations of the composition are listed in Table 2. The builder (citric acid, and or sodium citrate) is provided in builder particles.

TABLE 2
Example formulations of the composition (levels
are percent by weight of the composition).

| Component | Example | | | | |
|---|---|---|---|---|---|
| Material | F | G | H | I | J |

Builder Particles

| | | | | | |
|---|---|---|---|---|---|
| Citric Acid | 2 | 3 | 1 | | |
| Sodium Citrate | | | 1 | 2 | 10 |
| Polyethylene | 8 | 9 | 10 | 12 | 10 |
| Glycol, Weight | | | | | |
| Average | | | | | |
| Molecular | | | | | |
| Weight 9000 | | | | | |
| Da | | | | | |

Fragrance Particles

| | | | | | |
|---|---|---|---|---|---|
| Polyethylene | — | — | 50 | 65 | 10 |
| Glycol, Weight | | | | | |
| Average | | | | | |
| Molecular | | | | | |
| Weight 4000 | | | | | |
| Da (first | | | | | |
| dispersant) | | | | | |
| Polyethylene | 60 | 55 | — | — | 40 |
| Glycol, Weight | | | | | |
| Average | | | | | |
| Molecular | | | | | |
| Weight 8000 | | | | | |
| Da (first | | | | | |
| dispersant) | | | | | |
| Encapsulated | 3 | 1 | 8 | 2 | 8 |
| Perfume | | | | | |
| Unencapsulated | 7 | 3 | 6 | 6 | 10 |
| Perfume | | | | | |
| Sodium | 10 | 13 | 12 | 8 | 10 |
| Bicarbonate | | | | | |
| (first solubility | | | | | |
| agent) | | | | | |
| Sodium Acetate | 10 | 16 | 12 | 5 | 2 |
| trihydrate | | | | | |
| (second | | | | | |
| solubility | | | | | |
| agent) | | | | | |

An example follows:
A. A composition comprising:
about 1% to about 10% by weight of said composition a builder; and a plurality of fragrance particles, wherein said fragrance particles comprise;
about 25% to about 80% by weight of said composition a first dispersant that is solid at 20 degrees Celsius;
about 9% to about 25% by weight of said composition a first solubility agent;
about 9% to about 30% by weight of said composition a second solubility agent; and about 1% to about 20% by weight of said composition perfume.
B. The composition according to Paragraph A, wherein said builder is selected from the group of citric acid, sodium citrate, glutamic acid diacetic acid, ethyl gallate, sodium silicate, sodium metasilicate, diethylenetriamine, diethylenetriaminepentaacetic acid pentasodium salt, diethylenetriaminepentaacetic acid, and methylglycinediacetic acid.
C. The composition according to Paragraph A or B, wherein said first dispersant is selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.
D. The composition according to any of Paragraphs A to C, wherein said first solubility agent is a salt of carbonate, optionally a salt of carbonate selected from the group of sodium carbonate, sodium bicarbonate, calcium carbonate, and combinations thereof.
E. The composition according to any of Paragraphs A to D, wherein said first solubility agent differs from said first dispersant.
F. The composition according to any of Paragraphs A to E, wherein said second solubility agent is a salt hydrate.
G. The composition according to any of Paragraphs A to F, wherein said second solubility agent is sodium acetate trihydrate.
H. The composition according to any of Paragraphs A to G, wherein said first dispersant is a water soluble polymer, optionally wherein said first dispersant is polyethylene glycol having a weight average molecular weight from about 3000 to about 13000.
I. The composition according to any of Paragraphs A to H, wherein said perfume is encapsulated perfume.
J. The composition according to any of Paragraphs A to I, wherein said fragrance particles comprise said builder.
K. The composition according to any of Paragraphs A to J, wherein said builder is dispersed in said fragrance particles.
L. The composition according to any of Paragraphs A to J, wherein said builder is coated on said fragrance particles.
M. The composition according to any of Paragraphs A to I, wherein said builder is provided as part of said fragrance particles or as a separate builder particle.
N. The composition according to any of Paragraphs A to M, wherein said fragrance particles and said builder are contained within a container and are in contact with one another.
O. The composition according to any of Paragraphs A to I, wherein said composition further comprises a plurality of builder particles comprising a second dispersant and said builder.
P. The composition according to Paragraph O, wherein said second dispersant is selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.
Q. The composition according to Paragraph N or P, wherein said second dispersant differs from said first dispersant.
R. The composition according to any of Paragraphs N to Q, wherein said plurality of fragrance particles comprise a first dye and said builder particles comprise a second dye, wherein said second dye differs from said first dye.
S. The composition according to any of Paragraphs N to R, wherein said composition comprises a greater number of fragrance particles than said builder particles.
T. A process for treating laundry with the composition of any of Paragraphs A to S comprising steps of:
providing laundry in a washing machine;
dispensing said composition into said washing machine;
contacting said laundry with water;
dissolving said composition in said water to form a laundry treatment liquor, and contacting said laundry with said laundry treatment liquor.
U. The process according to Paragraph T further comprising the step of:
dispensing an acidic treatment composition into said washing machine, wherein said acidic treatment composition comprises from about 10% to 99% by weight of said acidic treatment composition organic acid.
V. An array of laundry treatment products comprising:
the composition according to any of Paragraphs A to S; and
an acidic treatment composition comprising from about 10% to about 99% by weight of said acidic treatment composition organic acid.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
about 1% to about 10% by weight of said composition a builder; and
a plurality of fragrance particles, wherein said fragrance particles comprise:
about 25% to about 80% by weight of said composition a first dispersant that is solid at 20 degrees Celsius;
about 9% to about 25% by weight of said composition a first solubility agent;
about 9% to about 30% by weight of said composition a second solubility agent; and
about 1% to about 20% by weight of said composition perfume.

2. The composition according to claim 1, wherein said fragrance particles comprise said builder.

3. The composition according to claim 2, wherein said first dispersant is a water soluble polymer.

4. The composition according to claim 2, wherein said builder is selected from the group of citric acid, sodium citrate, glutamic acid diacetic acid, ethyl gallate, sodium silicate, sodium metasilicate, diethylenetriamine, diethylenetriaminepentaacetic acid pentasodium salt, diethylenetriaminepentaacetic acid, and methylglycinediacetic acid.

5. The composition according to claim 2, wherein said first dispersant is selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.

6. The composition according to claim 1, wherein said builder is coated on said fragrance particles.

7. The composition according to claim 1, wherein said builder is dispersed in said fragrance particles.

8. The composition according to claim 1, wherein said first solubility agent is a salt of carbonate.

9. The composition according to claim 1, wherein said second solubility agent is a salt hydrate.

10. The composition according to claim 1, wherein said second solubility agent is sodium acetate trihydrate.

11. The composition according to claim 1, wherein said first solubility agent is a salt of carbonate and said second solubility agent is sodium acetate trihydrate.

12. The composition according to claim 11, wherein said first dispersant is selected from the group of polyethylene glycol, sodium acetate, sodium chloride, sodium silicate, polypropylene glycol polyoxoalkylene, polyethylene glycol fatty acid ester, polyethylene glycol ether, sodium sulfate, starch, and mixtures thereof.

13. The composition according to claim 11, wherein said first dispersant is polyethylene glycol having a weight average molecular weight from about 3000 to about 13000.

14. The composition according to claim 13, wherein said perfume is encapsulated perfume.

15. The composition according to claim 1, wherein said composition further comprises a plurality of builder particles comprising a second dispersant and said builder.

16. The composition according to claim 15, wherein said builder is selected from the group of citric acid, sodium citrate, glutamic acid diacetic acid, ethyl gallate, sodium silicate, sodium metasilicate, diethylenetriamine, diethylenetriaminepentaacetic acid pentasodium salt, diethylenetriaminepentaacetic acid, methylglycinediacetic acid, and mixtures thereof.

17. The composition according to claim 15, wherein said second dispersant is selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.

18. The composition according to claim 15, wherein said first dispersant is a water soluble polymer.

19. The composition according to claim 15, wherein said plurality of fragrance particles comprise a first dye and said builder particles comprise a second dye, wherein said second dye differs from said first dye.

20. A composition comprising:
about 1% to about 10% a builder; and
a plurality of fragrance particles, wherein said fragrance particles comprise:
about 25% to about 80% by weight of said composition polyethylene glycol having a weight average molecular weight from about 3000 to about 13000;
about 9% to about 25% by weight of said composition sodium bicarbonate;
about 9% to about 30% by weight a said composition sodium acetate trihydrate; and
about 1% to about 20% by weight of said composition perfume;
wherein said builder is provided as part of said fragrance particles or as a separate builder particle.
